(19) United States
(12) Patent Application Publication
(10) Pub. No.: US 2001/0035044 A1
(43) Pub. Date: Nov. 1, 2001

(54) Measuring arrangement and method for determination of soot concentrations

(75) Inventors: Bjorn Larsson, Lidingo (SE); Ulrich Schonauer, Eggenstein (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/841,724

(22) Filed: Apr. 25, 2001

(30) Foreign Application Priority Data
Apr. 27, 2000 (DE) 100 20 539.9

(51) Int. Cl. G01N 37/00

(52) U.S. Cl. 73/28.01

(57) ABSTRACT

A measuring arrangement is provided for soot particle-bearing gases, having a soot sensor in a gas conduit, and its use in methods for determining a soot concentration in flowing, soot particle-bearing gases, wherein at least one component stream of a soot particle-bearing gas stream in a gas conduit flows by and/or through at least one electrically-conducting structure. The problem presents itself of making available a sensor and a method for determining soot concentrations in flowing gases, with which even small amounts of soot can be reliably recorded. The problem is solved by a measuring arrangement with a soot sensor, which has an electrically-conducting structure with an electrical charge, and wherein an arrangement for generating another electrical charge on the soot particles is provided in the gas upstream of the soot sensor. The problem is furthermore solved in that the soot sensor has an electrically-conducting structure, which is set at ground potential, and wherein an arrangement for generating an electric charge on the soot particles is provided in the gas upstream from the soot sensor.

### BACKGROUND OF THE INVENTION

The invention relates to a measuring arrangement for soot particle-bearing gases, having a soot sensor in a gas conduit and its use, furthermore a method for determining a soot concentration in flowing, soot particle-bearing gases, wherein at least one component stream of a soot particle-bearing gas stream in a gas conduit flows by and/or through an electrically-conducting structure.

International patent application publication WO 94/23281 describes a representative measuring arrangement of this type and a method for detecting soot particles in a flowing gas. A probe is used which projects into the flow and which is triboelectrically charged by soot particles flowing past the probe. The triboelectric charging of the probe is recorded by an electrical circuit and evaluated as an amount of soot particles in the stream. The probe here possesses an electrically-conducting core with an insulation layer, which insulates the conducting core from the particle stream.

German patent DE 198 17 402 C1 also describes a sensor arrangement for quantitative determination of electrically-conducting or charged particles, especially soot particles, in a gas stream. The sensor arrangement is made from a charged condenser, wherein particles can flow through between the condenser plates. When flowing through, the particles change the charging of the condenser and the necessary charging current. The changes in the charging current are evaluated as amounts of particles in the gas. The sensor arrangement is heated in order to avoid short circuits by a coating with particles.

Furthermore, using a soot sensor having a molded body which is open-pored at least in the direction of flow, an electrical heating element and a temperature sensor for determining soot particles in gas streams is known to the applicant. Here, the molded body is used to filter and gather soot particles from a component gas stream. The heating element is used at fixed time intervals to heat up the molded body, and the accumulated soot is burned. The development of heat is recorded with the aid of the temperature sensor and evaluated as an amount of soot in the gas.

With the described measuring arrangements and methods for determining soot concentrations, only the particles chancing to flow past the sensor are recorded. With low particle concentrations in the gas, however, the methods fail, since not enough particles flow past to be able to conduct an exact evaluation.

### BRIEF SUMMARY OF THE INVENTION

The problem presents itself of making available a sensor and method for determining soot concentrations in flowing gases, with which even small amounts of soot can be reliably recorded.

The problem is solved by a measuring arrangement with a soot sensor, which has an electrically-conducting structure with an electric charge and wherein, an arrangement for generating another electric charge on the soot particles is provided in the gas upstream of the soot sensor. Here, it is especially advantageous if the soot particles are acted upon with an electric charge opposite to that of the structure.

This problem is furthermore solved in that the soot sensor has an electrically-conducting structure, which is set to ground potential, and in which an arrangement for generating an electric charge on the soot particles is provided in the gas upstream of the soot sensor.

In both cases, the electrically-conducting structure represents an arbitrarily configured electrode of an electric field arrangement. The measuring arrangement uses the coulombic attractive forces in order to steer the soot selectively in the direction of the soot sensor and to make them accessible to an evaluation there.

The measuring arrangement is consequently suited for directing even the smallest amounts of soot in the gas stream in the direction of the structure or the soot sensor and there to bring about a selective depositing of the soot. Accordingly, not only are soot particles deposited on the soot sensor, whose path in the gas conduit chances to be crossed by the soot sensor, but owing to the charge of the soot particles, particles are also deposited on the soot sensor which otherwise would have passed by this unhindered together with the gas stream. The other charge of the soot particles brings about that they are attracted by the structure and consequently not only move with the gas stream along the gas conduit, but also transverse thereto toward the soot sensor. Accordingly, more soot particles are caught by the soot sensor than would be possible without a charging, and the sensitivity of the soot sensor is increased.

In order to generate another electric charge between structure and soot particles, in one embodiment of the invention, one pole of a power supply is connected with the structure and the other pole of the power supply, at least upstream of the soot sensor, is connected with the gas conduit, wherein the soot sensor is arranged electrically insulated from the gas conduit. It is also possible, however, for an electrically-conducting grid subject to flow-through to be arranged upstream of the soot sensor in the soot particle-bearing gas, for one pole of a power supply to be connected with the structure, and for the other pole of the power supply to be connected with the grid. These two arrangements for charging the soot particles can also be used if the structure is merely set to ground potential.

The expression “grid” is here merely intended to describe an arrangement which does not substantially disturb the flow of the gas and as far as possible does not diminish the amount of particles, but which allows a charging of the soot particles flowing by. Included here are arrangements, such as nets, perforated sheets, honeycomb structures, rods, wires or current guides.

It is advantageous if the electrically-conducting structure is at least partially made of a metal. In particular for measuring soot concentrations in the exhaust gas conduit of motor vehicles, often reaching temperatures up to 100° C., the use of noble metals with a high melting point is appropriate there. Here, the electrically-conducting structure can be subject to flow-through by the gas and/or have an open porosity. It is also advantageous if the electrically-conducting structure is constructed as a layered structure. Using a thick or thin layer technique or plasma spraying offers itself here for the construction of the layered structure.

In order to be able to conduct an evaluation of the amount of soot deposited on the soot sensor, it is advantageous if the soot sensor has, in addition to the structure, at least one electrical heating element and at least one temperature sensor.

Here, the soot sensor can have in addition an electrically non-conducting molded body, which is open-pored at least in the direction of flow, wherein the structure is arranged downstream of or beside the molded body in the direction of flow.

By a molded body which is open-pored at least in the direction of flow is quite generally to be understood an element with open porosity or penetrating openings or holes in the direction of flow, which can exist ordered or unordered. Here, it can be a matter of temperature-resistant, simple perforated sheets, tubes, bundles of fibers or wool, porous ceramics, porous glasses, porous thin layers or the like. Instead, a very rough surface can also be used as a molded body, which is open-pored in the direction of flow.

It is especially advantageous if the soot sensor has at least one molded body which is open-pored in the direction of flow, wherein its surfaces are at least partially covered with the electrically-conducting structure.

Owing to its large surface, the molded body acts as a filter, which in combination with the structure further increases the soot-collecting action.

The electrically-conducting structure can be made at least partially of a catalytically active material. For this purpose, for example, platinum and its alloys, or platinum-rhodium compounds are suitable.

The electric heating element and the temperature sensor can be arranged directly on or in the molded body. Likewise, the electric heating element, the temperature sensor, the molded body and the structure can be arranged on a support.

With respect to the numerous configuration possibilities of sensor geometry of the soot sensor, care should be taken that conductive compounds, such as catalytically active material or soot itself, do not lead to signal disturbances or short circuits, which can impair a trouble-free operation of the heating elements or the temperature sensor. For this purpose, possibly the use of one or more electrically-insulating, soot-tight layers can be necessary between heating element and structure and/or molded body or between temperature sensor and structure and/or molded body. However, formation of a short circuit due to soot, especially on the electrical heating element, can even be desirable or used for evaluation purposes.

The measuring arrangement is exceptionally useful for determining a particle concentration in flowing, particle-bearing gases, especially of soot particles in exhaust gases of motor vehicles.

The problem is solved for the method in that the structure is connected to one pole of a power supply and thus acted upon by a positive or negative charge, and in that upstream of the structure, the other pole of the power supply is connected either to the gas conduit electrically insulated from the structure and/or to a grid electrically insulated from the structure, and thus the soot particles are provided with a charge opposite to the charge of the structure, wherein the charged soot particles, as soon as they reach the vicinity of the charged structure, are attracted and remain adhering on or near the charged structure.

In the vicinity of the charged structure, the soot particles are here generally found, as soon as the different charges or potentials of the structure and the soot particles interact with one another. By an adhesion “near the structure” is to be understood, for example, a deposit of soot particles on a molded body arranged in front of, beside or after the structure, on a filter or on a layer.

The problem is further solved for the method in that the structure is set to ground potential, and in that upstream of the structure an electrical charge is applied either to the gas conduit electrically insulated from the structure and/or to a grid electrically insulated from the structure, and thus the soot particles are provided with a charge different from the ground potential on the structure, wherein the charged soot particles, as soon as they reach the vicinity of the structure, are attracted and release their charge on or near the structure and remain adhering.

It can be advantageous if the structure is constructed to be subject to flow-through and/or with an open porosity. Instead, an electrically non-conducting molded body, which is open-pored in the direction of flow, can be allocated to the structure. Here, it has proven satisfactory if the structure is arranged upstream of, downstream of, or next to the molded body which is open-pored in the direction of flow.

The determination of the amount of soot particles in the gas stream ideally takes place in that the structure and/or the molded body coated with soot particles is heated up in defined time intervals by means of an electric heating element to the ignition temperature of the soot, and in that a development of heat arising from the combustion of soot particles is evaluated as a direct measure for an amount of soot particles in the gas stream.

Here, the time intervals can be selected in a fixed manner, or be selected on the basis of an evaluation of operating data. For a soot sensor in the exhaust conduit of a diesel motor, this could mean, for example, that the heating of the molded body is started after a predetermined number of cold starts or as a function of diesel fuel consumed. By operating data are accordingly generally to be understood information which relate to the generation of exhaust gas and which can be placed in any correlation with a development of soot in the exhaust gas.

After reaching the ignition temperature of soot on the structure and/or on the molded body, the electrical heating element can be operated with a constant heat output, which is measured with the temperature sensor by the heat development occurring from the combustion of soot particles. The temperature rise is evaluated as a direct measure for the burned amount of soot particles on the structure and/or on the molded body, and the amount of soot particles in the gas stream can be determined therefrom.

For this purpose, an intelligent control unit is necessary, which can convert the temperature rise into an amount of soot by a specified calculation routine. The amount of soot, which is burned on the structure and/or on the molded body, is proportional to the amount of soot which has flowed past the soot sensor since the installation or since the last heating up of the structure and/or molded body.

After reaching the ignition temperature of the soot on the structure and/or on the molded body, the temperature of the structure and/or molded body can instead be kept substantially isothermal by means of withdrawing the heat output of the electric heating element. The heat output can be evaluated as a direct measure for the burned amount of soot particles on the structure and/or molded body, and the amount of soot particles in the gas stream can be determined therefrom. Here too, an intelligent control unit is necessary.

After evaluation of the temperature rise or the heat output change and conversion into a burned amount of soot on the structure and/or molded body, the amount of soot which flows by the soot sensor is deduced. For this purpose, a correlation scheme, which contains the correlation between deposits on the structure and/or molded body and the amount of soot flowing past, must be stored in the intelligent control unit. If an amount of soot is calculated which lies above, for example, a legally specified threshold, then the emission of an optical or acoustical warning signal or an intervention into regulation of the combustion process can take place through the control unit. If, however, an amount of soot is calculated, which lies, for example, beneath a specified threshold, then no action is initiated by the control unit, but the calculated value for the amount of soot is stored. A subsequently initiated second determination of the amount of soot, repeated at a certain interval from this first determination of the soot amount, must now be processed in connection with the first determination or the value saved for this purpose. The amount of soot calculated from the second determination must be added to the stored value by the control unit, since in this case only the sum of the two values in the correlation scheme provides the correct value. If the threshold has also not yet been exceeded after the second determination, then the sum from both determinations must be stored and used further for subsequent calculations according to the above scheme.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a sectional schematic view of a soot sensor according to one embodiment of the invention with a porous molded body and a structure in layered form;

FIG. 2 is a sectional schematic view of a soot sensor according to a second embodiment of the invention with a combination of a porous molded body and a structure;

FIG. 3 is a longitudinal section, schematic view of a soot sensor according to a third embodiment of the invention with a honeycomb molded body;

FIG. 4 is a cross sectional view of the soot sensor from FIG. 3 taken along line A-A″;

FIG. 5 is a longitudinal section, schematic view of a soot sensor according to a fourth embodiment of the of the invention with a conducting structure with a honeycomb structure;

FIG. 6 is a cross sectional view of the soot sensor from FIG. 5 taken along line B B″; and

FIG. 7 is a schematic diagram of a measurement arrangement for determination of soot concentrations.

### DETAILED DESCRIPTION OF THE INVENTION

FIG. 1 shows in cross section a soot sensor 11, suited for use in the measuring arrangement, having a support 1 of Al₂O₃ ceramic. On one side of the support 1, a meander-shaped temperature sensor 2 is arranged, here a platinum resistance element in thin film technology. This temperature sensor 2 is covered by a dense, electrically insulating layer 3 of Al₂O₃. An electrically-conducting structure 4 in layer form is situated on the insulating layer 3. An open-pored molded body 5 made of a foamed ceramic is arranged over the structure 4. On the other side of the support 1, a meander-shaped heating element 6 is arranged. The soot sensor is installed into a gas conduit such that the heating element 6 does not stand in contact with the gas stream.

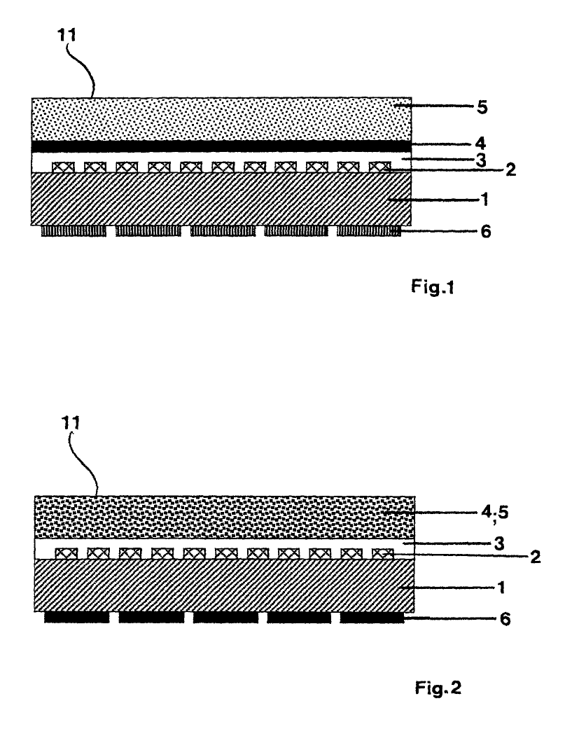

FIG. 2 depicts in cross section a soot sensor 11, suited for use in the measurement arrangement, having a support 1 of Al₂O₃. On one side of the support 1, a meander-shaped temperature sensor 2 is arranged, covered by a dense, electrically-insulating layer 3 of Al₂O₃. On this is situated an open-pored ceramic molded body 4, which bears on its outer and inner surfaces the conducting structure 5 in the form of a metallic coating, without thereby losing the open porosity of the molded body. On the other side of the support 1, a meander-shaped heating element 6 is arranged. The soot sensor is installed into a gas conduit such that the heating element 6 does not come into contact with the gas stream.

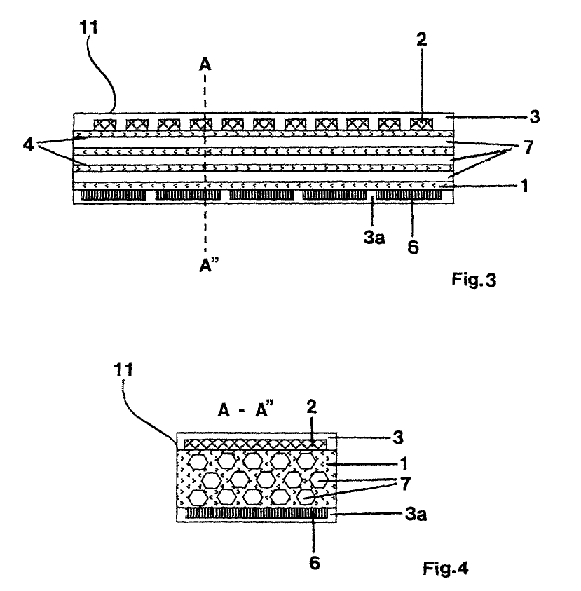

FIG. 3 illustrates a soot sensor 11 in longitudinal section with a dense support 1 of Al₂O₃, which has a honeycomb structure 7 in the direction of the gas flow. On one side of the support 1, a meander-shaped temperature sensor 2 is arranged, protected from the gas atmosphere and from impurities, under an electrically-insulating layer 3 of Al₂O₃. On the surface of the individual honeycombs 7, a metallic layer is situated as a conducting structure 4, which is electrically connected with the temperature sensor 2 and with ground potential. On the other side of the support 1, a meander-shaped heating element 6 is arranged, which is covered by a further electrically-insulating layer 3a for protection against impurities.

FIG. 4 depicts the soot sensor 11 from FIG. 3 in cross section with the support 1 and the honeycomb structure 7, wherein the conducting structure 4 covers the surface of the honeycombs 7.

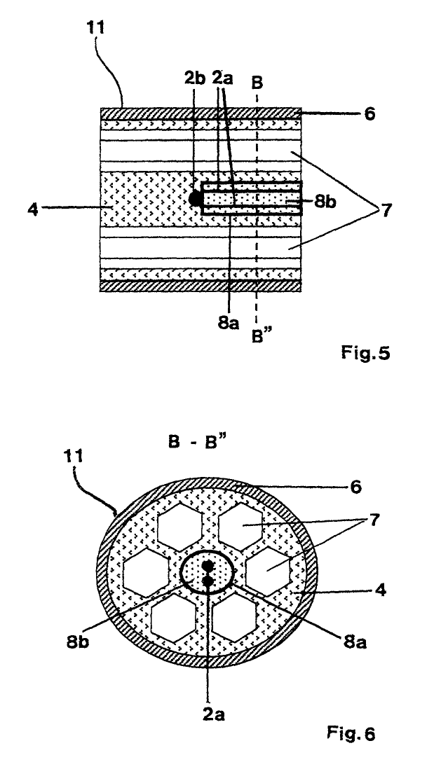

FIG. 5 shows a soot sensor 11 in longitudinal section with a conducting structure 4 of metal, which has a honeycomb structure 7 in the direction of the gas flow. A thermocouple 2a is arranged in the structure 4, protected from the gas atmosphere and impurities, in a mineral-insulated conduit having a tube 8a closed on one end and a mineral powder filling 8b. Here, the thermocouple tip 2b of the thermocouple 2a projects out of the tube 8a and is conductingly connected with the structure 4, in order to be able to record temperature changes as rapidly as possible. On the exterior of the structure 4, a heating element 6 is wound, which can be covered by a further electrically-insulating layer (not shown here) for protection against impurities.

FIG. 6 illustrates the soot sensor 11 from FIG. 5 in cross section with the conducting structure 4 and the honeycomb structure 7.

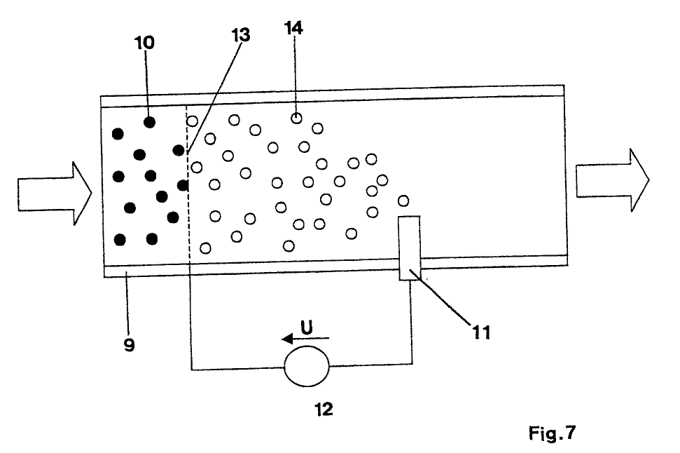

FIG. 7 depicts a measuring arrangement according to the invention having an exhaust gas conduit 9, through which an exhaust gas with soot particles 10 flows. A soot sensor 11 is provided with an electrically-conducting structure, which is connected to the positive pole of a power source 12, as well as an electrically-conducting grid 13, which is connected to the negative pole of the power source 12. Both the soot sensor 11 and the grid 13 are arranged electrically insulated from the exhaust gas conduit. This is, however, not separately represented here. The soot particles 10 with the exhaust gas flow through the grid 13 and take up a negative electric charge. The negatively charged soot particles 14 move with the exhaust gas further in the direction of the soot sensor 11, which has the positively charged structure (not separately represented) relative to the grid (13). The charged soot particles 14 are drawn from the structure, which is positively charged relative to the grid (13), in the direction of the soot sensor 11, release their negative charge on the structure, and remain adhering on the soot sensor 11.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A measuring arrangement for soot-particle bearing gases, comprising a soot sensor (11) in a gas conduit (9), wherein the soot sensor (11) has an electrically-conducting structure (4) with an electrical charge, and an arrangement in the gas upstream of the soot sensor (11) for generating another electrical charge on the soot particles (14).

2. A measuring arrangement for soot particle-bearing gases, comprising a soot sensor (11) in a gas conduit (9), wherein the soot sensor (11) has an electrically-conducting structure (4) which lies at ground potential, and an arrangement in the gas upstream of the soot sensor (11) for generating an electric charge on the soot particles (14).

3. The measuring arrangement according to claim 1, wherein the soot sensor (11) is arranged electrically insulated from the gas conduit (9), one pole of a power source (12) is connected with the structure (4), and another pole of the power supply (12) is connected with the gas conduit (9) at least upstream of the soot sensor (11)

4. The measuring arrangement according to claim 1, wherein the soot sensor (1 1) is arranged electrically insulated from the gas conduit (9), an electrically-conducting grid (13) subject to flow-through is arranged in the soot particle-bearing gas upstream of the soot sensor (11), one pole of a power supply (12) is connected with the structure (4), and another pole of the power source (12) is connected with the grid (13).

5. The measuring arrangement according to claim 1, wherein the electrically-conducting structure (4) at least partially comprises metal.

6. The measuring arrangement according claim 1, wherein the electrically-conducting structure (4) is subject to flow-through by the gas and/or has an open porosity.

7. The measuring arrangement according to claim 1, wherein the electrically-conducting structure (4) has as a layered structure.

8. The measuring arrangement according to claim 1, wherein the soot sensor (11) besides the structure (4) has at least one electric heating element (6) and at least one temperature sensor (2; 2a).

9. The measuring arrangement according to claim 8, wherein the soot sensor (11) additionally has an electrically non-conducting molded body (5) which is open-pored at least in a direction of gas flow, wherein the structure (4) is arranged upstream of, downstream of, or beside the molded body (5).

10. The measuring arrangement according to claim 1, wherein the soot sensor (11) additionally has an electrically non-conducting molded body (5) which is open-pored at least in a direction of gas flow, wherein surfaces of the molded body (5) are at least partially covered with the electrically-conducting structure (4).

11. The measuring arrangement according to claim 1, wherein the electrically-conducting structure (4) at least partially comprises a catalytically active material.

12. The measuring arrangement according to claim 9, wherein the electric heating element (6) and the temperature sensor (2; 2a) are arranged directly on or in the molded body (5).

13. The measuring arrangement according to claim 9, wherein the electric heating element (6), the temperature sensor (2; 2a), the molded body (5), and the structure (4) are arranged on a support (1).

14. The measuring arrangement according to claim 1, adapted for determining a particle concentration in flowing, particle-bearing gases.

15. A method for determining a soot concentration in flowing, soot particle-bearing gases, comprising flowing at least one component stream of a soot particle-bearing gas stream in a gas conduit (9) by and/or through at least one electrically-conducting structure (4), connecting the structure (4) to one pole of a power supply (12) such that the structure (4) is acted upon with a positive or negative charge, connecting another pole of the power supply (12) upstream of the structure (4) either to the gas conduit (9) insulated from the structure (4) and/or to a grid (13) electrically insulated from the structure (4), such that soot particles are provided with a charge opposite to the charge of the structure (4), wherein the thus-charged soot particles, as soon as they reach a vicinity of the charged structure (4), are attracted and remain adhering to or near the charged structure (4).

16. A method for determining a soot concentration in flowing, soot particle-bearing gases, comprising flowing at least one component stream of a soot particle-bearing gas stream in a gas conduit (9) by and/or through at least one electrically-conducting structure (4), setting the structure (4) at ground potential, applying an electrical charge upstream of the structure (4) either on the gas conduit (9) electrically insulated from the structure (4) and/or on a grid (13) electrically insulated from the structure (4), such that soot particles are provided with another charge relative to the ground potential on the structure (4), wherein the thus-charged soot particles, as soon as they reach a vicinity of the structure (4), are attracted and release their charge on or near the structure (4) and remain adhering.

17. The method according to claim 15, wherein the structure (4) is constructed to be subject to flow-through and/or with an open porosity.

18. The method according to claim 15, wherein an electrically non-conducting molded body (5), which is open-pored in a direction of gas flow, is allocated to the structure (4).

19. The method according to claim 18, wherein the structure (4) is arranged upstream of, downstream of, or beside the molded body (5), which is open-pored in a direction of gas flow.

20. The method according to claim 18, further comprising heating the structure (4) and/or molded body (5) coated with soot particles to an ignition temperature of the soot by an electrical heating element (6) at defined time intervals, and evaluating a heat development arising from combustion of the soot particles as a direct measure for an amount of the soot particles in the gas stream.

21. The method according to claim 20, wherein the time intervals are selected in a fixed manner.

22. The method according to claim 20, wherein the time intervals are selected based on an evaluation of operating data.

23. The method according to claim 20, comprising operating the electrical heating element (6) with a constant heat output after reaching the ignition temperature of soot on the structure (4) and/or on the molded body (5), measuring the heat development arising from the combustion of soot particles with the temperature sensor (2; 2a), evaluating a temperature rise as a direct measure for a burned amount of soot particles on the structure (4) and/or on the molded body (5), and determining an amount of soot particles in the gas stream therefrom.

24. The method according to claim 20, comprising holding the temperature of the structure (4) and/or of the molded body (5) substantially isothermal, after reaching the ignition temperature of the soot on the structure (4) and/or molded body (5), by withdrawing heat output of the electrical heating element (6), evaluating the heat output as a direct measure for a burned amount of soot particles on the structure (4) and/or the molded body (5), and determining an amount of soot particles in the gas stream therefrom.
